(19) United States
(12) Patent Application Publication
(10) Pub. No.: US 2011/0213669 A1
(43) Pub. Date: Sep. 1, 2011

(54) Allocation of Resources

(75) Inventors: Milan Vojnovic, Cambridge (GB); Thanh Tien Nguyen, New York, NY (US)

(73) Assignee: Microsoft Corporation, Redmond, WA (US)

(21) Appl. No.: 12/714,238

(22) Filed: Feb. 26, 2010

(51) Int. Cl. G06Q 30/00; G06F 15/16

(52) U.S. Cl. 705/14.71; 709/226; 705/26.3

(57) ABSTRACT

Allocation of resources is described for example, where the resources are computers, communications network resources or advertisement slots. In an example a weighted proportional resource allocation mechanism is described in which a resource provider seeks to maximize revenue whilst users seek to maximize their satisfaction in terms of the utility of any resource allocation they receive minus any payment they make for the resource allocation. In an example, the provider determines discrimination weights (using information about resource constraints and other factors). For example, the discrimination weights are published to the users; the users submit bids for the resources in the knowledge of the discrimination weights and the provider allocates the resources according to the bids and the discrimination weights. In an example keyword auctions for sponsored search are considered where the resources are advertisement slots and where the constraints include the relative positions of the advertisements.

### BACKGROUND

Mechanisms for allocating resources such as computers or communications network links have used auction-based approaches. For example, a resource provider may invite bids from users and allocate the resources according to those bids such that the allocations are proportional to the bids. This is known as a proportional allocation mechanism. Existing proportional allocation mechanisms are able to allocate resources such as single processors or single network links but are not generally applicable in situations where the resources are more complex.

Resources offered by providers typically need to be allocated to users (which may be automated users or human users) with two competing goals. The provider generally seeks to maximize revenue whilst the users seek to maximize their satisfaction in terms of the utility of any resource allocation they receive minus any payment made for the resource allocation. Allocation mechanisms are sought which enable these goals to be balanced in a simple and effective manner which is straightforward for users. For example, the allocation mechanism is desired to work for complex resource constraints.

Mechanisms for allocating resources such as advertisement slots to advertisers are also known which use auction based approaches. However, current approaches typically assume that each advertisement slot is independent of other slots displayed in the same list and it is difficult to take into account inter-relationships between adverts in different slots in a simple and effective manner.

The embodiments described below are not limited to implementations which solve any or all of the disadvantages of known resource allocation mechanisms.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Allocation of resources is described for example, where the resources are computers, communications network resources or advertisement slots. In an example a weighted proportional resource allocation mechanism is described in which a resource provider seeks to maximize revenue whilst users seek to maximize their satisfaction in terms of the utility of any resource allocation they receive minus any payment they make for the resource allocation. In an example, the provider determines discrimination weights (using information about resource constraints and other factors). For example, the discrimination weights are published to the users; the users submit bids for the resources in the knowledge of the discrimination weights and the provider allocates the resources according to the bids and the discrimination weights. In an example keyword auctions for sponsored search are considered where the resources are click-through rates allocated per advertiser and where the constraints derive from the observed click-through rates over allocations of ad slots to adverts.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a resource allocation system;

FIG. 2 is a block diagram of a method at a resource allocation system;

FIG. 3 is a block diagram giving more detail of a method of selecting discrimination weights for users;

FIG. 4 is an example of a polyhedron specifying resource constraints;

FIG. 5 is a schematic diagram of a resource allocation system for allocating communications network bandwidth to users;

FIG. 6 is a block diagram of an example method of forming a resource constraint polyhedron for use with the resource allocation system of FIG. 5;

FIG. 7 is a schematic diagram of a resource allocation system for allocating data centre machines to jobs;

FIG. 8 is a schematic diagram of a resource allocation system for allocating online advertisement system resources;

FIG. 9 is a block diagram of a method for forming a resource constraint polyhedron for use with the resource allocation system of FIG. 8;

FIG. 10 is another example of a resource constraint polyhedron;

FIG. 11 is a schematic diagram of a resource allocation system with a plurality of providers;

FIG. 12 illustrates an exemplary computing-based device in which embodiments of a resource allocation system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in exemplary systems for allocating communications network bandwidth, allocating data centre resources and in a system for selling advertisement slots, the systems described are provided as examples and not a limitation. As those skilled in the art will appreciate, the present examples are suitable for application in a variety of different types of resource allocation systems.

In examples, a weighted proportional allocation mechanism is used whereby providers can apply different weights to users. These weights (also referred to as discrimination weights) are a method for the provider to provide different prices to different users. For example, the provider is aware that the users seek to maximize their satisfaction and uses this to select appropriate weights taking into account any constraints on the resources in order to maximize revenue.

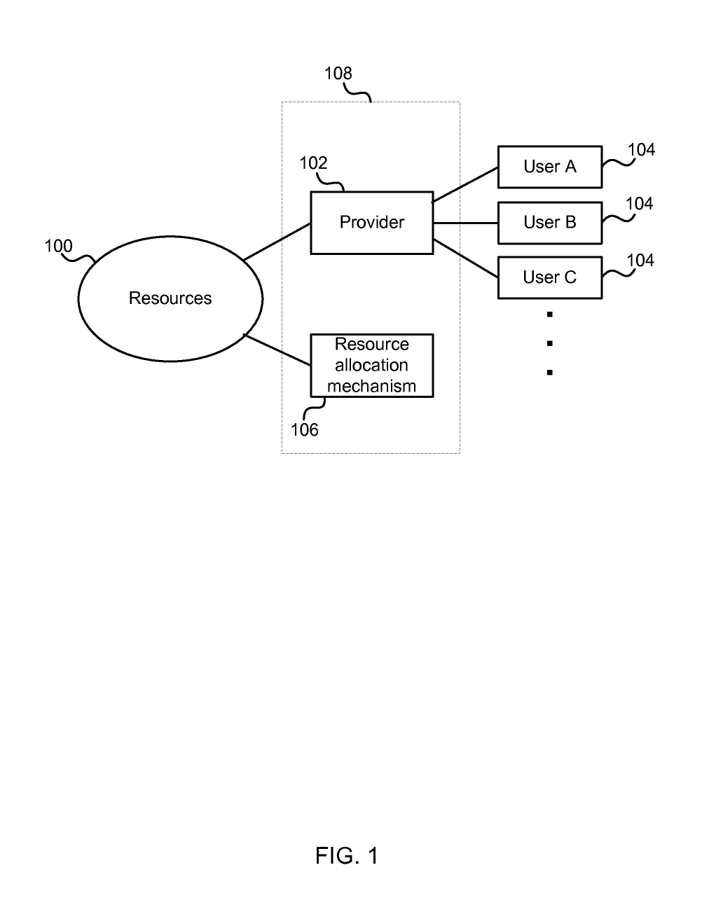

FIG. 1 is a schematic diagram of a resource allocation system 108 comprising a provider 102 and a resource allocation mechanism 106. The provider 102 is computer implemented and may comprise a web service or other service accessible to a plurality of users 104. The users may be human users, automated users or other resource allocation systems. The provider is arranged to receive information from the users such as utility functions, bids, resource requirements or other information. The provider is arranged to send information to the users such as discrimination weights and other information as explained in more detail below. The resource allocation mechanism 106 is any suitable mechanism which is able to receive resource allocation information from the provider 102 and to implement those allocations by communicating with resources 100 or in any other way. The resource allocation mechanism may itself be computer implemented. The resources 100 are any items, services, hardware, software or other entities of limited capacity, duration or other quality which it is required to allocate amongst users.

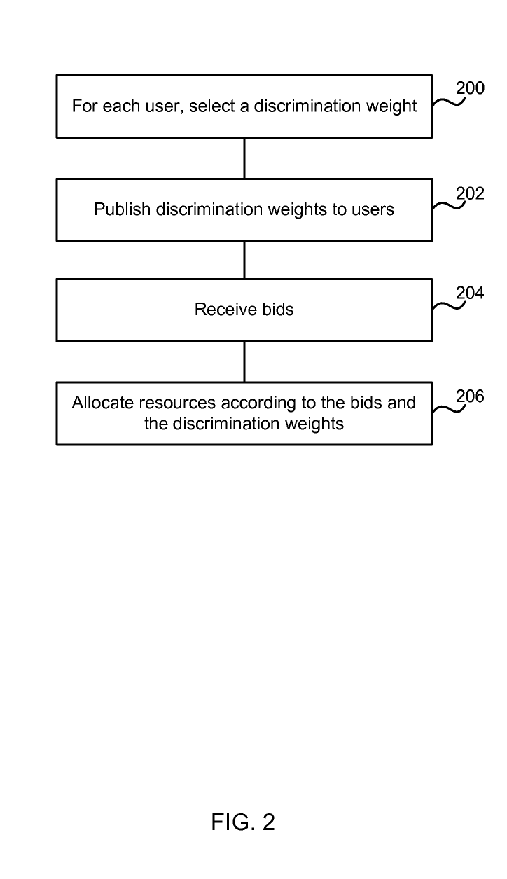

FIG. 2 is a block diagram of a method at a resource allocation system such as that of FIG. 1. A provider 102 selects 200, for each user, a discrimination weight, publishes 202 the discrimination weights to the users, receives bids 204 from the users and allocates resources according to the bids and the discrimination weights 206. For example, both the users and the provider aim at selfishly optimizing their respective payoffs. In an example the provider generally seeks to maximize revenue whilst the users seek to maximize their satisfaction in terms of the utility of any resource allocation they receive minus any payment made for the resource allocation.

For each user a discrimination weight is selected 200 by the resource provider. The discrimination weights provided are given by \vec{C}=(C₁, . . . , Cₙ). The discrimination weights are a method for the provider to provide different prices to different users based on, for example, the amount of resources that are necessary for each user. The discrimination weights are automatically determined by the provider using information given to the provider by the users regarding their needs, any historical information on the previous requirements of the users or any other relevant information. The provider publishes 202 information on all of the discrimination weights \vec{C} to all of the users. The provider may be arranged to assume that the users will react to the published discrimination weights in a selfish way in order to maximize their share of the resources. Each user makes a bid \vec{w}=(w₁, . . . , wₙ), all of the bids are received 204 by the provider. The resources are then allocated according to the bids received and the discrimination weights. The allocation to a user i is given by xᵢ=Cᵢwᵢ/Σⱼwⱼ. That is, the amount of resource allocated to a given user is proportional to the bid of that user, multiplied by the discrimination weight of that user and inversely proportional to the sum of all the bids. The total allocation of resources to all of the users is denoted by an allocation vector \vec{x}=(x₁, . . . , xₙ).

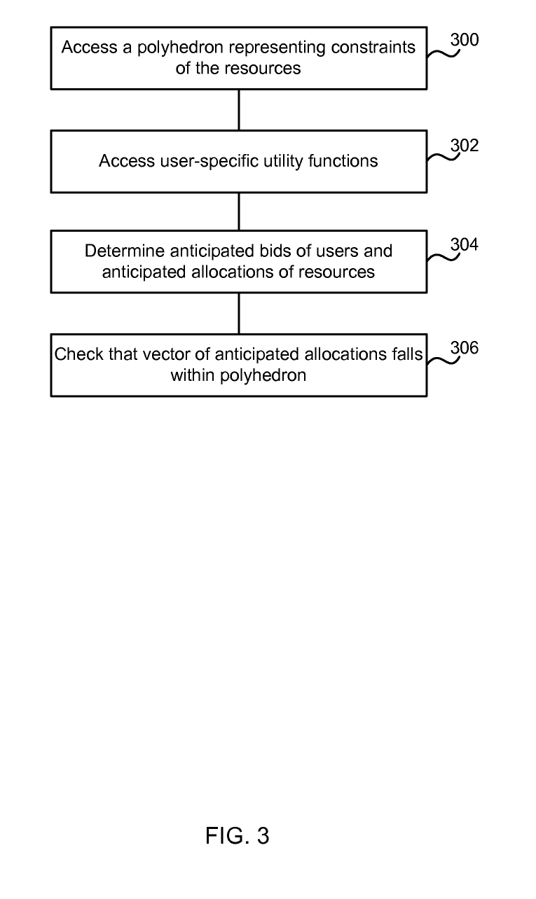

FIG. 3 is a block diagram giving more detail of a method (which may be carried out automatically at the provider) of selecting discrimination weights for the users comprising accessing 300 a polyhedron representing constraints of the resources. By using a polyhedron to represent the constraints, complex constraints may be taken into account in contrast to previous approaches. For example, where the resources are communications network links the constraints may relate to the total amount of bandwidth available on each link. This is explained in more detail below. User specific utility functions are accessed 302 and anticipated bids of users and anticipated allocations of resources are determined 304. That the vector of anticipated allocation falls within the polyhedron is checked 306 to ensure the allocation is feasible.

In order to determine whether the allocation is feasible a polyhedron representing the constraints of the resources is accessed 300. The polyhedron is formed at the provider from information on the number of users and any constraints on the system or resources. The polyhedron P is a convex set of the form P={\vec{x}εR₊ⁿ:A\vec{x}≦\vec{b}} for some matrix A and a vector \vec{b} with non negative elements. A and \vec{b} can have arbitrarily many rows. For example \vec{b} corresponds to the total allocation vector \vec{x} which must be less than the constraints on the system which are denoted by the matrix A. The constraints on the system can be any relevant constraints such as the total bandwidth of the system, capacity of any links in the system, total processors available, availability of data, number of simultaneous jobs, advertisement slots available, any probabilities or dependencies that need to be taken into account or any other relevant constraints.

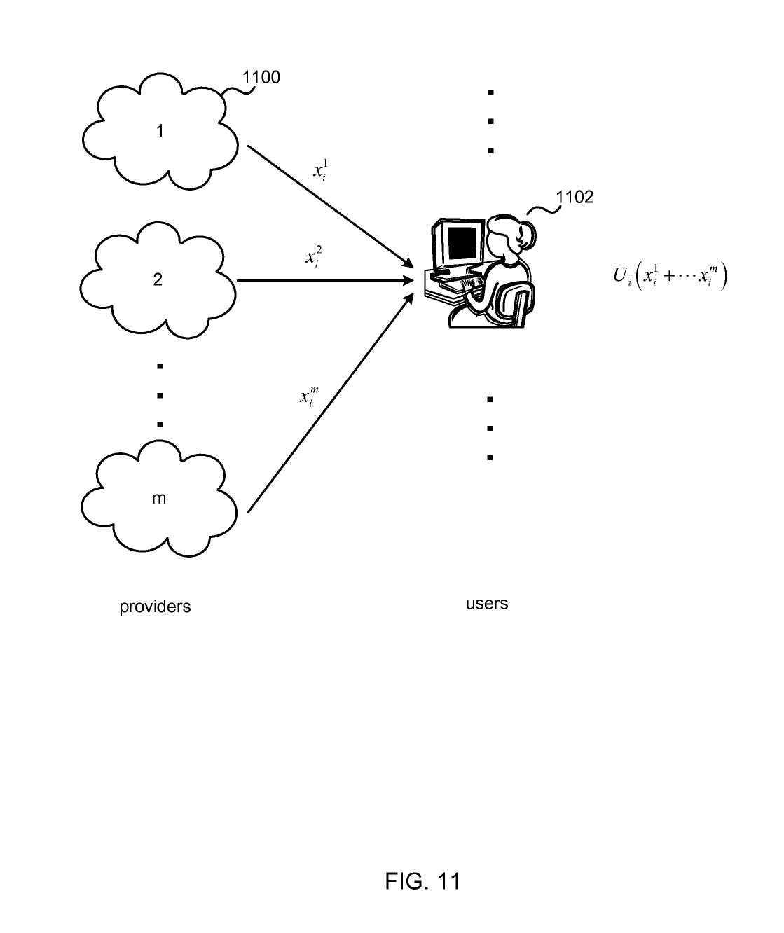

The user specific utility functions are accessed 302. Each utility function represents the usefulness of the allocated resources to each user. For example, the utility or usefulness of the allocation to each user is given by the function Uᵢ(xᵢ)which is a non-negative, non-decreasing and concave function. The utility functions can be heterogeneous, as each user has different needs. The utility function can be provided by the user to the provider based on their needs, or the provider can determine a utility function for each user based on historical use, catalogues of utility functions or by any other suitable means. The utility function may take into account any existing allocation of the resources available to the user, from the provider or another provider. A system with multiple providers is discussed further with reference to FIG. 11 below.

The anticipated bids of users and anticipated allocations of resources are determined 304 using assumptions about how the user's will act. In an example, each user is assumed to choose a bid wᵢ which will allow them to maximize their surplus i.e. to obtain a maximum share of the utility, or resource, for a minimal bid Uᵢ(xᵢ)−wᵢ. The provider, may determine a unique Nash outcome because the provider has information from the user on their requirements, or based on historical requirements or other suitable methods of providing the utility function to the provider or of the provider independently determining the utility function. The provider may select the discrimination weights \vec{C} that maximize the revenue R=Σⱼwⱼ.

The assumption that the user will act selfishly to maximize his surplus and that the provider will act selfishly to maximize his revenue can be used to select the appropriate discrimination weights and determine the expected allocation vector. Given a discrimination weight Cᵢ and the sum of the bids

$${\sum }_{j}^{ } {w}_{j} ,$$

user i chooses a bid wᵢ that maximizes his surplus i.e. solves

$$USER \text{:} maximize {U}_{i} ( \frac{{w}_{i}}{{\sum }_{j \neq i}^{ } {w}_{j} + {w}_{i}} {C}_{i} ) - {w}_{i} over {w}_{i} \geq 0.$$

The provider anticipates the selection of the bids by the users using information provided by the user on their needs or other available information to form the utility function and solves the following problem
PROVIDER: maximize R(\vec{x}) over \vec{x}εP

Under the assumed behavior of the users, the Nash equilibrium of the game can be analyzed. A Nash equilibrium exists and is unique and at Nash equilibrium there is an equilibrium relation between revenue and the allocation of resources to the user. The equilibrium is captured by an implicit function.

The revenue R(\vec{x}) is an implicit function of \vec{x} given by

$${\sum }_{i}^{ } \frac{{U}_{i}^{′} ( {x}_{i} ) {x}_{i}}{{U}_{i}^{′} ( {x}_{i} ) {x}_{i} + R ( \vec{x} )} = 1.$$

Given discrimination weights \vec{C}, there is a unique allocation corresponding to the unique Nash equilibrium. Vice versa, given an allocation \vec{x}, there is a weight \vec{C} such that \vec{x} is the corresponding outcome. Thus by acting selfishly each user is able to maximize their surplus and the provider is able to maximize the revenue from the resource.

The anticipated allocation vector which denotes the sum of the resources allocated to all users \vec{x} is checked to see that it falls within the polyhedron 306. The anticipated allocation vector is feasible if it falls within a polyhedron i.e. i.e. \vec{x}εP where P, the polyhedron, is a set in R₊ⁿ which specifies the constraints on the available resources. If the allocation vector does not fall within the polyhedron i.e. A\vec{x}≦\vec{b} then the prediction of the total amount of resources allocated exceeds the amount available given the constraints on the system.

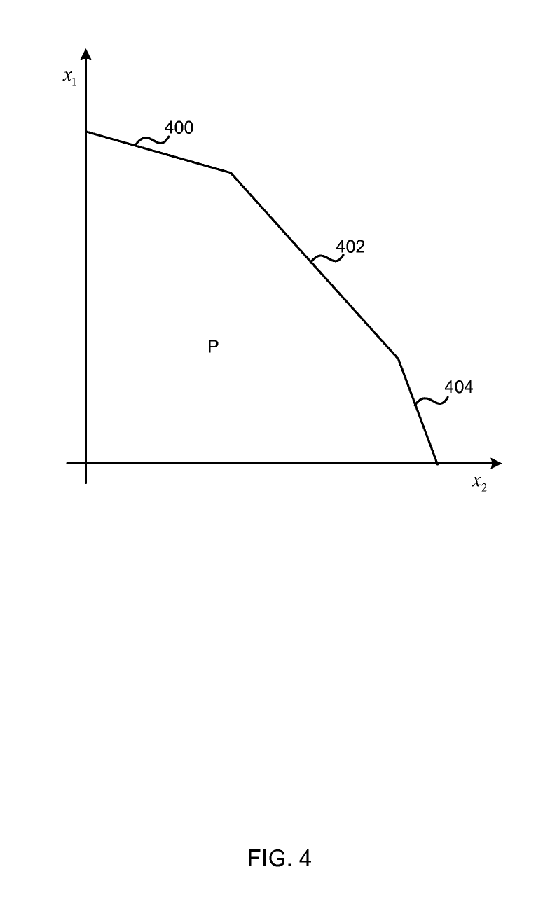

FIG. 4 is an example of a polyhedron specifying resource constraints. The constraints of the resources are specified as plurality of inequalities 400, 402, 404 i.e. A\vec{x}≦\vec{b} which define the polyhedron. The polyhedron in this case is specified for two users. The allocations are x₁ and x₂ with each of 400, 402 and 404 representing an inequality in a row of the matrix A. If there were more than two users it would be necessary to increase the number of dimensions. The polyhedron has a number of dimensions equal to the number of users.

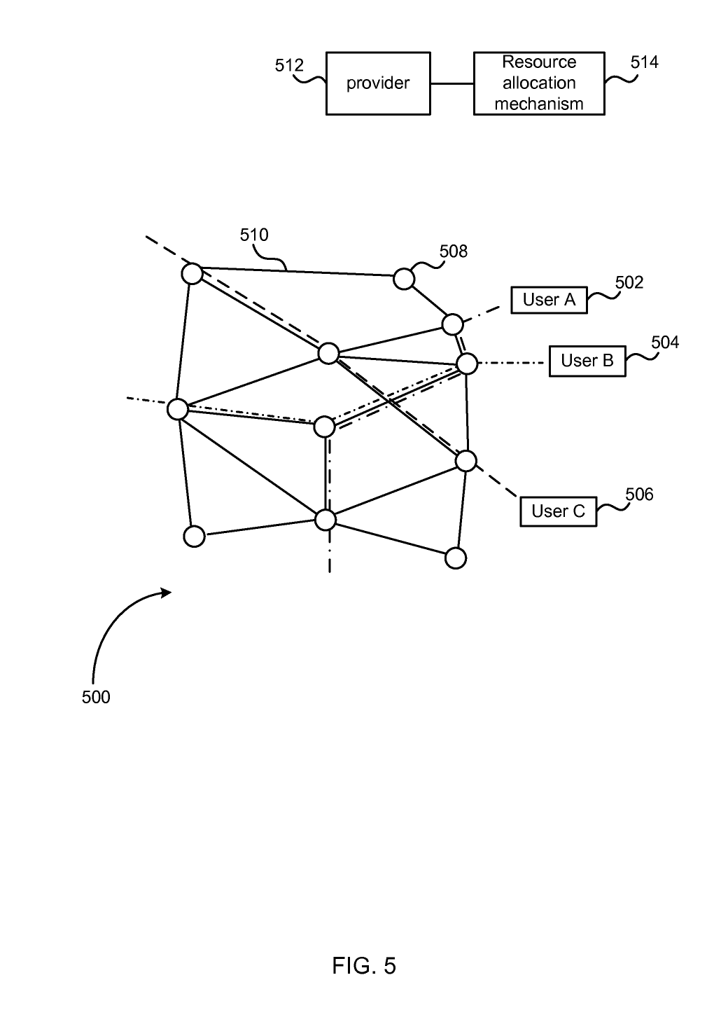

FIG. 5 is a schematic diagram of a resource allocation system for allocating communications network bandwith to users comprising a communications network 500, a number of users 502, 504, 506, nodes in the communication network 508 and links in the communication network 510. The communications network bandwith is allocated by a provider 512 to each of the users 502, 504, 506 using a resource allocation mechanism 514. In this example each user i is sending traffic along a path Pᵢ and xᵢ is the data transfer rate for each user i. Each link e 510 has a certain capacity cₑ. In an example there are three users but there may be any number of users. Users can share bandwidth on any individual link but a constraint on the system is that the total capacity of the link should not be exceeded. The traffic can be redistributed at the nodes 508. A provider controls a network of links and allocates bandwidth to users on the basis of discrimination weights \vec{C} and user bids \vec{w}.

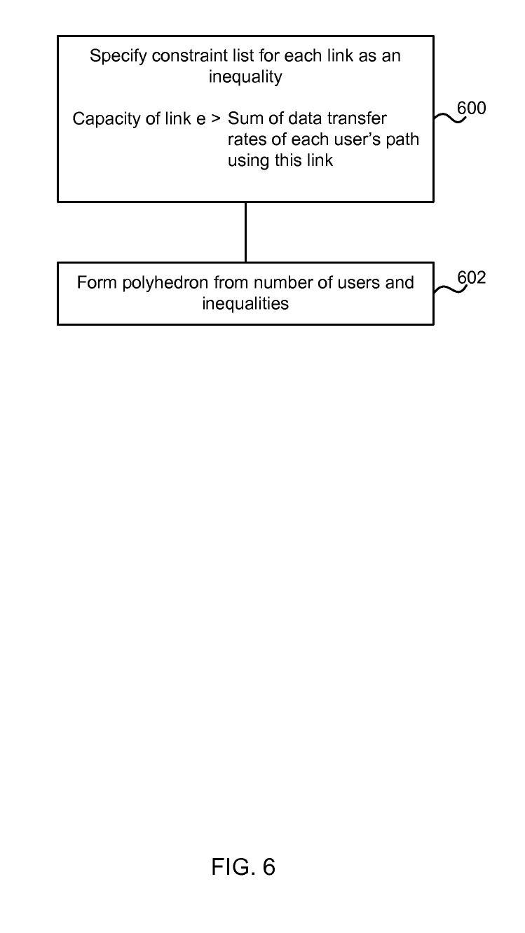

FIG. 6 is a block diagram of an example method of forming a resource constraint polyhedron for use with the resource allocation system of FIG. 5. A constraint list for each link, for example the total capacity, is specified as an inequality 600 and a polyhedron is formed from the number of users and the inequalities. In this case a resource constraint is associated with each link e:Σ_{i:eεP}ᵢxᵢ≦cₑ which states that the sum of the data transfer rate for all users along each path in the network must be less than the total capacity of each link in the path. Thus the polyhedron P is formed 602 from the number of users 502, 504, 506 and the constraint that the sum of allocated data transfer rates for each user on each path should not exceed the total capacity of the path on the network. The discrimination weights \vec{C} are selected on the basis of the polyhedron and the anticipated user bids such that the anticipated allocation vector \vec{x} falls within the polyhedron. The user is assumed to try to find a bid that maximizes the user's payoff Uᵢ(xᵢ)−wᵢ. The revenue provider has incentive to choose a discrimination weight \vec{C} to maximize their revenue R(\vec{x}) subject to the constraints described above. The optimal allocation which allows the user to maximize their surplus and the provider to maximize their revenue will occur at the Nash equilibrium.

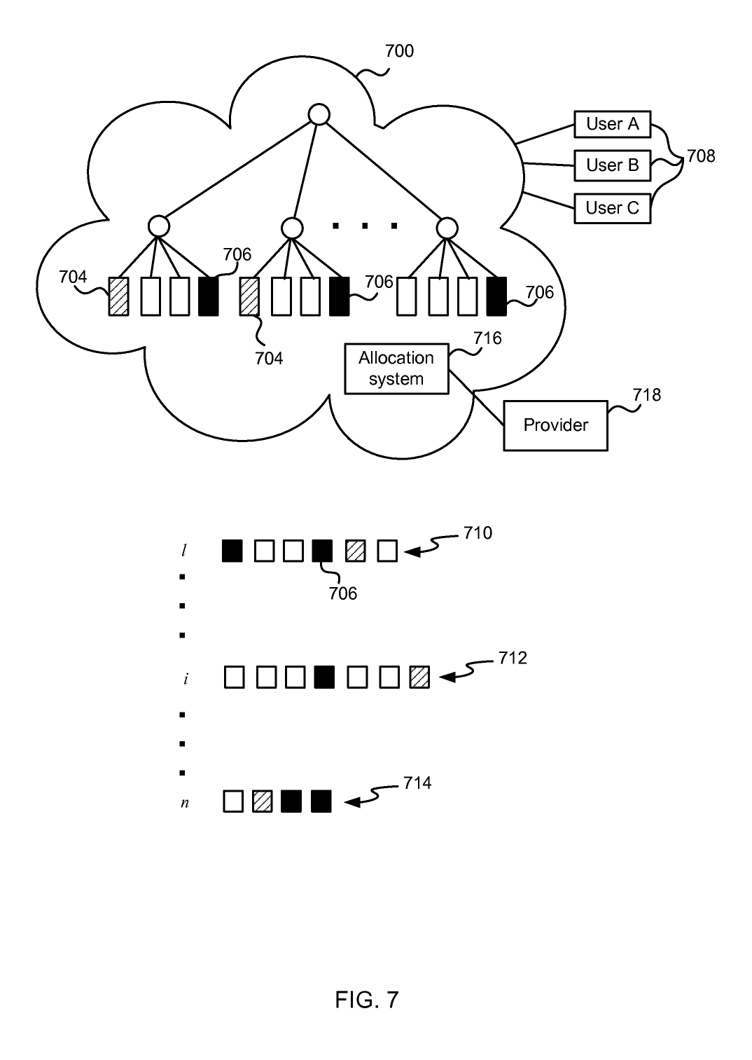

FIG. 7 is a schematic diagram of a resource allocation system for allocating data centre machines to jobs. A data centre 700 consists of many clusters of machines. Blocks of data 704, 706 have multiple copies across many clusters. Each of the users 708 of the data centre needs to finish a job 710, 712, 714 which requires reading many different blocks of data across the machines in a data centre. The resources are allocated using an allocation system 716 by the allocation provider 718. In an example Dⱼⁱ is the amount of data 706 of type j that job i 712 needs to process. The utility function of each job i is related to its finishing time tᵢ which is the maximum processing time of the job across all types of data that it requests.

Each job 710, 712, 714 is assumed to try to maximize the utility Uᵢ(xᵢ) where xᵢ=1/tᵢ. xᵢ is the minimum among Dᵢ^{j}/sᵢ^{j} where sᵢ^{j} is the speed that job i can process data of type j. Thus the best scenario for the user is that the maximum amount of data is processed in the shortest time possible for a minimal bid. Data centers such as data center 700 are typically complex systems. However, in many cases the constraints on sᵢ^{j}, such as the distribution of data across the cluster, the speed or number of the processors etc, can be captured by convex constraints and a polyhedron can be formed as described above. Therefore under the assumption that both users and providers act selfishly an appropriate allocation vector \vec{x} can be found.

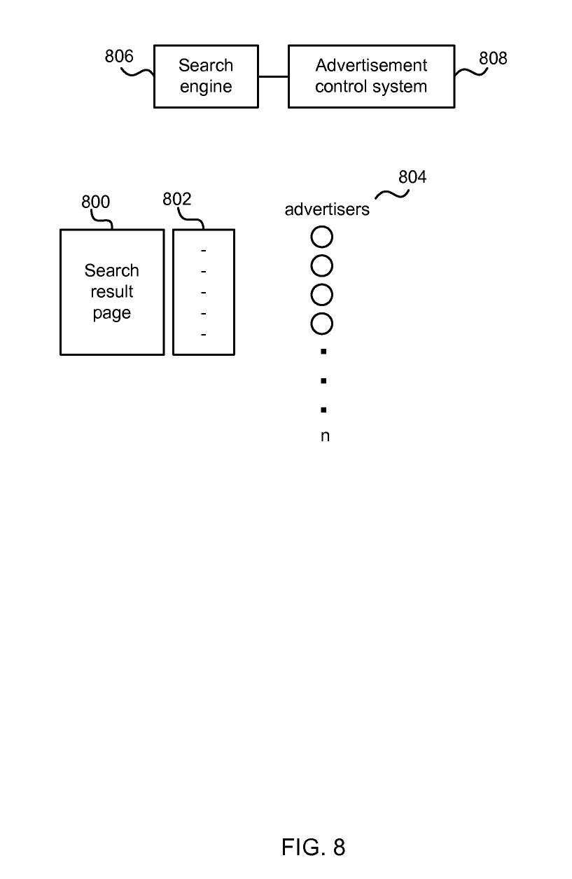

In the example of resource allocation for communications network bandwidth and in the example of a resource allocation system for allocating data centre machines to jobs the detailed internal structure of the resources may be known only to the provider and a simple interface from the provider may be available to users. Some users may require more resources than others. However, all users would be presented with the same interface. The allocation system 716 accounts for this diversity of requirements while keeping a simple interface to users. A further example of a system in which weighted resource allocation can be applied to ensure the most efficient allocation of resources with respect to both the user and the provider is discussed below with respect to FIG. 8.

FIG. 8 is a schematic diagram of a resource allocation system for allocating advertisement slots to advertisers. A search results page 800 also presents a number of advertisement slots 802 from advertisers 804. The order of the advertisements are allocated by the search engine 806 using an advertisement control system 808. For example, the relative positions of advertisements in the slots may affect what users are willing to bid for an advertisement slot.

Sponsored search is a type of online advertising by an internet search engine 806 which comprises selling advertisement slots 802 that appear along side search results 800 when certain search keywords are used. The advertisement slots 802 are allocated to a set of top ranked advertisers 804. The allocation is carried out using keyword auctions that assign advertisements to slots 802 depending on the bid and individual weights of the bids. The weight for the advertiser 804 is, for example, the expected click-through-rate for this advertiser; each advertiser pays a fixed price per click where the price is the lowest price sufficient to retain the advertisers rank. The reason to introduce these weights is explained by the click-through rates rᵢⱼ, which is the probability that users click on advertisement i when it is placed at position j. It is commonly assumed that rᵢⱼ=αᵢ×βᵢ, where αᵢ is the quality of an advertisement i capturing how relevant an advertisement is to the search keyword and βⱼ is the quality of the position. A large value of βⱼ is associated with a good position among the sponsored links. However, this does not capture externalities among the advertisements 802. For example the valuation of a bid for position two depends on what advertisement is being shown in position one. In addition, it is not clear what the real connection is between the weights assigned to each advertiser 804 and the advertisements quality αᵢ, as the search engine might strategically assign these weights to maximize the revenue. Convex constraints can be used to capture a general dependency among click through rates, and providers can strategically decide different weights for each user.

Convex constraints represented as polyhedrons can be used to capture a general model of keyword auctions. In an example where there is an auction for a single keyword with n advertisers 804 bidding to have their advertisement appear as a sponsored search result 802 there is a finite set of outcomes depending on which bidder gets displayed in which position.

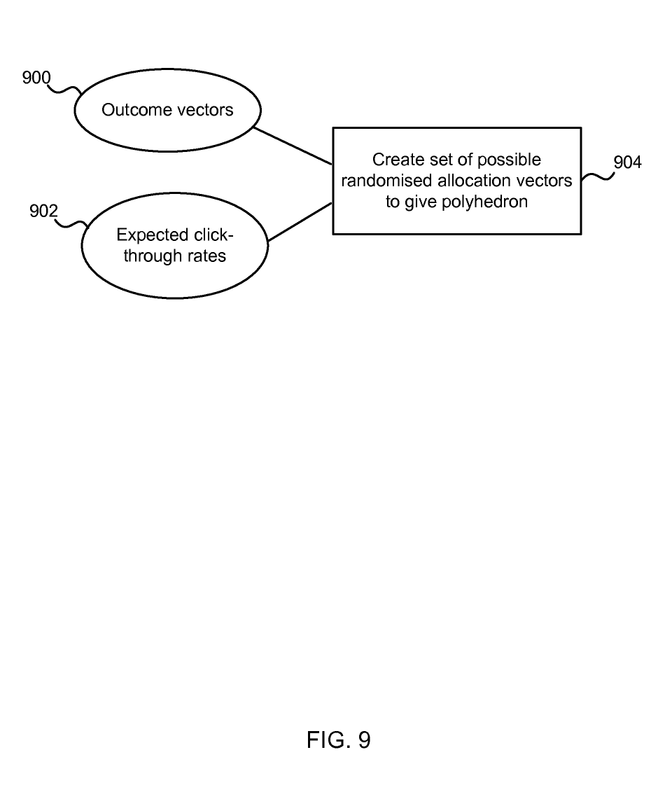

FIG. 9 is a block diagram of a method for forming a resource constraint polyhedron for use with the resource allocation system of FIG. 8. Outcome vectors 900 and expected click through rates 902 are used to create a set of possible randomized allocation vectors to give a polyhedron 904.

Each outcome vector 900 is a n dimensional vector whose coordinates are the expected number of clicks that the corresponding advertiser gets. More precisely, \vec{y¹}, . . . , \vec{y^{N}} are all the possible outcome vectors 900 and \vec{y^{k}}=(y₁^{k}, . . . , yₙ^{k}), where xᵢ^{k} is the expected number of clicks 902 that advertiser i receives at outcome k. To think of the keyword auction as a convex resource allocation there is a need to allow randomization in the allocation of bidders to position. Choosing between the deterministic allocations by the probability distribution \vec{p}=(p₁, . . . , p_{N}), we have that Σⱼpⱼ\vec{y^{j}} is the vector whose coordinates correspond to the expected number of clicks that an advertiser receives 902. The set of expected allocation vectors obtained in this way is the convex hull conv(\vec{y¹}, . . . , \vec{y^{N}})={\vec{x}:\vec{x}=Σⱼpⱼ\vec{y^{j}}, pⱼε [0,1] for every j and Σⱼpⱼ=1}. It is assumed that if an advertisement is moved from position (by showing one fewer advertisement) the expected number of clicks received by the remaining advertisements does not decrease. Under this assumption it can be shown that the set of all possible randomized allocation vectors, that is the convex hull conv(\vec{y¹}, . . . , \vec{y^{N}}), can be written as {x:A\vec{x}≦\vec{b}, where A,b\vec{≦}0} and used to form a resource constraint polyhedron.

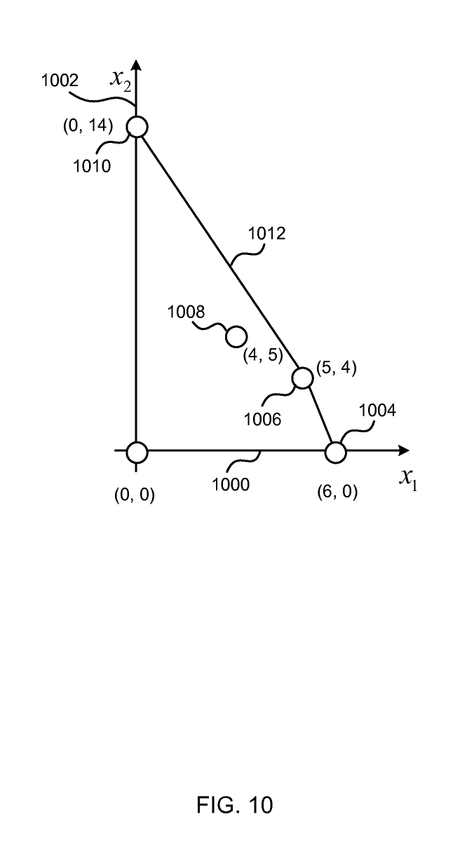

FIG. 10 is another example of a resource constraint polyhedron. In this case the resource constraint polyhedron has been formed using the method described with reference to FIG. 8 and FIG. 9 above for allocating advertisement slots to advertisements. In this example we have two advertisement slots 1 1000 and 2 1002. Each slot has an observed number of clicks illustrated on axes x1 and x2 in FIG. 10 where FIG. 10 shows four observations 1004, 1006, 1008, 1010. In an example the predicted number of bids is dependant on what advertisement is being shown in the other position. In addition the search engine might strategically assign these weights to maximize the revenue. A probability distribution is formed as described above which creates a best fit polyhedron 1012 of all possible outcome vectors, taking the additional constraints into account. It is therefore possible to find the appropriate weights and allocations for each user.

FIG. 11 is a schematic diagram of a resource allocation system with a plurality of providers 1100. Each user 1102 is provided with a specific allocation xᵢ^{k} by a provider 1100.

In an oligopoly of multiple competing providers 1100 each provider allocates resources according to the weighted proportional allocation mechanism described above. Each provider k has a different constraint on resources which is captured by a convex set Pₖ. In a general case each user 1102 can receive resources from any provider and is concerned only with the total allocation received over all providers. However, additional constraints can be encoded in the convex set Pₖ.

For each user i 1102, the utility of an allocation (xᵢ^{k},i=1, . . . , n,k=1, . . . , m) is Uᵢ(Σₖxᵢ^{k}). xᵢ=Σₖxᵢ^{k} denotes the total allocation to user i 1102, by a provider k. \vec{x}=(xᵢ^{k},i=1, . . . , n,k=1, . . . m) is an allocation under a weighted proportional sharing mechanism. The utility function is provided by the user or formed by the provider from the information available. The utility function can take into account any allocation from the provider or other providers.

The allocation of resources from multiple providers is analogue to the situation discussed with regard to FIG. 2 and FIG. 3 above that given \vec{x}, each provider k can find the weights (C₁^{k}, . . . , Cₙ^{k}) such that \vec{x} is the equilibrium of the weighted proportional sharing in the multiple providers 1100 setting. In this setting the payment of user i to provider k is wᵢ^{k}, and the users goal is to maximize the resources obtained from each provider for a minimum total of bids i.e. Uᵢ(Σₖxᵢ^{k})−Σₖwᵢ^{k}, where xᵢ^{k}=Cᵢ^{k}wᵢ^{k}/Σᵢwᵢ^{k}.

The provider k obtains the revenue R^{k} that is in the following correspondence with the allocation \vec{x^{k}}

$${\sum }_{i = 1}^{n} \frac{{U}_{i}^{′} ( {x}_{i}^{- k} + {x}_{i}^{k} ) {x}_{i}^{k}}{{U}_{i}^{′} ( {x}_{i}^{- k} + {x}_{i}^{k} ) {x}_{i}^{k} + {R}^{k} )} = 1$$

for every i, Uᵢ(x) is a concave function and Xᵢ^{-k} is the total allocation that user i received from other providers The marginal utility for a user with provider k decreases if the user already received allocations from other providers. As a result, provider k may extract smaller revenues due to competition with other providers.

\vec{x} is an equilibrium allocation if for every k, the allocation vector \vec{x}=(x₁^{k}, . . . , xₙ^{k}) maximizes R^{k} over the set Pₖ. The discrimination weights and the revenue can be calculated according to the allocation vector \vec{x} of all providers. With these discrimination weights, under users' selfish behavior \vec{x} will be the outcome. From the providers' perspective, an equilibrium is an \vec{x} where no provider has an incentive to unilaterally change its allocation vector. In this case each provider will retain an equilibrium share of the revenue.

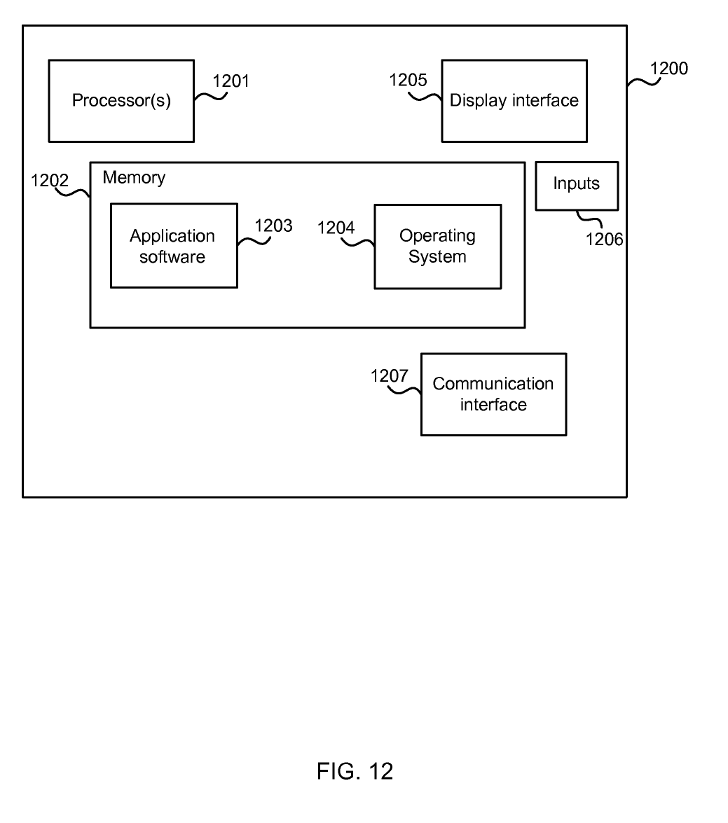

Reference is now made to FIG. 12, which illustrates various components of an exemplary computing-based device 1200 which can be implemented as any form of a computing and/or electronic device.

The computing-based device 1200 comprises one or more inputs 1206 which are of any suitable type for receiving user input, for example source code or the executable code, or direct input from the user, e.g. in the form of input from a keyboard and/or a pointing device, or any other suitable human-computer interface. The computing-based device 1200 also comprises at least one communication interface 1207 for communicating with one or more communication networks, such as the internet (e.g. using internet protocol (IP)) or a local network. The communication interface 1207 can be used to communicate with one or more external computing devices, such as servers, databases or storage devices.

Computing-based device 1200 also comprises one or more processors 1201 which can be microprocessors, controllers or any other suitable type of processors for processing computing executable instructions to control the operation of the device in order to allocate resources to users. Platform software comprising an operating system 1204 or any other suitable platform software can be provided at the computing-based device 1200 to enable application software 1203 to be executed on the device.

The computer executable instructions and software can be provided using any computer-readable media, such as memory 1202. The memory 1202 is of any suitable type such as random access memory (RAM), a disk storage device of any type such as a magnetic or optical storage device, a hard disk drive, or a CD, DVD or other disc drive. Flash memory, EPROM or EEPROM can also be used.

An output interface 1205 is also provided such as a video and/or audio output to a display system integral with or in communication with the computing-based device 1200.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of allocating resources to a plurality of users comprising:
for each user, selecting a user-specific discrimination weight;
publishing the discrimination weights to the users;
from each user, receiving a bid;
for each user, allocating an amount of the resources which is related to that user's bid, a sum of the bids and that user's discrimination weight.

2. A method as claimed in claim 1 wherein selecting the discrimination weights comprises:
accessing a polyhedron representing constraints of the resources and selecting the discrimination weights on the basis of the polyhedron.

3. A method as claimed in claim 2 wherein selecting the discrimination weights comprises, for each user, accessing a user-specific utility function.

4. A method as claimed in claim 3 wherein selecting the discrimination weights comprises, determining anticipated bids of the users on the basis of the utility functions and so obtaining anticipated allocations of the resources to the users; and checking that a vector of the anticipated allocations of the resources falls within the polyhedron.

5. A method as claimed in claim 1 wherein the step of selecting the discrimination weights seeks to maximize a sum of the bids.

6. A method as claimed in claim 1 wherein, for each user, allocating an amount of the resources which is related to that user's bid, a sum of the bids and that user's discrimination weight comprises using the following equation: xᵢ=Cᵢwᵢ/Σⱼwⱼ where xᵢ is the allocation to user i, wᵢ is the bid of user i and Cᵢ is the discrimination weight of user i.

7. A method as claimed in claim 1 wherein the resources are provided by a plurality of providers and wherein each of those providers carries out the method.

8. A method as claimed in claim 7 wherein each user provides a utility function to each of the providers, that utility function taking into account any existing allocation of the resources available to the user.

9. A method as claimed in claim 1 wherein the resources are selected from any of: communications network bandwidth, advertisement slots, data center resources.

10. A method as claimed in claim 2 wherein constraints of the resources are expressed as a plurality of inequalities which define the polyhedron having a number of dimensions equal to the number of users.

11. A method of allocating advertisement slots to a plurality of advertisers comprising:
for each advertiser, selecting a user-specific discrimination weight;
publishing the discrimination weights to the advertisers;
from each advertiser, receiving a bid;
for each advertiser, allocating an amount of the resources which is related to that advertiser's bid, a sum of the bids and that advertiser's discrimination weight.

12. A method as claimed in claim 11 wherein selecting the discrimination weights comprises:
forming a polyhedron representing constraints of the advertisement slots and selecting the discrimination weights on the basis of the polyhedron.

13. A method as claimed in claim 12 wherein the step of forming the polyhedron comprises determining an outcome vector for each possible advertiser and advertisement slot combination using expected click through rate information and creating a set of randomized allocation vectors from the outcome vectors using a probability distribution.

14. A method as claimed in claim 13 wherein the polyhedron captures externalities among the advertisements.

15. A method as claimed in claim 11 wherein selecting the discrimination weights comprises, for each advertiser, accessing a user-specific utility function.

16. A method as claimed in claim 15 wherein selecting the discrimination weights comprises, determining anticipated bids of the advertisers on the basis of the utility functions and so obtaining anticipated allocations of the resources to the advertisers; and checking that a vector of the anticipated allocations of the advertisement slots falls within the polyhedron

17. An apparatus for allocating data center resources to a plurality of users comprising:
a processor arranged, for each user, to select a user-specific discrimination weight;
an output arranged to publish the discrimination weights to the users;
an input arranged to receive a bid from each user;
an allocation mechanism arranged, for each user, to allocate an amount of the resources which is related to that user's bid, a sum of the bids and that user's discrimination weight.

18. An apparatus as claimed in claim 17 comprising a memory storing a polyhedron representing constraints of the resources and arranging the processor to select the discrimination weights on the basis of the polyhedron.

19. An apparatus as claimed in claim 18 wherein the memory stores, for each user, a user-specific utility function.

20. An apparatus as claimed in claim 17 wherein the allocation mechanism is arranged, for each user, to allocate an amount of the resources using the following equation: xᵢ=Cᵢwᵢ/Σⱼwⱼ where xᵢ is the allocation to user i, wᵢ is the bid of user i and Cᵢ is the discrimination weight of user i.
